(19) United States
(12) Patent Application Publication
(10) Pub. No.: US 2018/0175344 A1
(43) Pub. Date: Jun. 21, 2018

(54) HOUSING MEMBER

(71) Applicant: Yazaki Corporation, Tokyo (JP)

(72) Inventors: Shigeyuki Ogasawara, Shizuoka (JP); Hideto Masuki, Shizuoka (JP)

(21) Appl. No.: 15/833,911

(22) Filed: Dec. 6, 2017

(30) Foreign Application Priority Data
Dec. 20, 2016 (JP) 2016-247085

(51) Int. Cl. H01M 2/10; H01M 2/20; H01M 10/48; H01M 10/42

(52) U.S. Cl. CPC H01M 2/1077; H01M 2/206; H01M 2220/20; H01M 10/425; H01M 10/486

(57) ABSTRACT

A housing member includes a housing body; a lid including respective closing portions for a plurality of openings forming a step; a hinge body that couples a reference-opening edge portion and an end portion of a reference closing portion and lets the lid turn with respect to the housing body; a first retaining mechanism that includes a first engaging body arranged between an offset opening and an offset closing portion and provided on one of an offset-opening edge portion and an end portion of the offset closing portion, and a first engaged body provided on the other, and retains the lid to the housing body at a closed position; and a second retaining mechanism arranged between the reference-opening edge portion and an end portion of the reference closing portion. The first engaging body and the first engaged body are formed to avoid exerting pressing force until being fully engaged.

### CROSS-REFERENCE TO RELATED APPLICATION(S)

The present application claims priority to and incorporates by reference the entire contents of Japanese Patent Application No. 2016-247085 filed in Japan on Dec. 20, 2016.

### BACKGROUND OF THE INVENTION

### 1. Field of the Invention

The present invention relates to a housing member.

### 2. Description of the Related Art

Conventionally, a housing member has been known in which the housing member includes a housing body that houses an object to be housed such as a conductive member (electrical wires and the like) via a housing opening, a lid that closes up the housing opening, and a hinge body that lets the lid turn with respect to the housing body between an opened position with respect to the housing opening and a closed position with respect to the housing opening. This type of housing member is disclosed in Japanese Patent Application Laid-open No. 2016-006722, for example. In this housing member, in order to improve closure of a housing chamber that houses the object to be housed, it is desirable that the lid be kept retained to the housing body at the closed position, and for this purpose, a retaining mechanism is provided between the housing body and the lid. The retaining mechanism includes an engaging body and an engaged body that engage in conjunction with a turning operation by the hinge body. One of the engaging body and the engaged body is provided on an edge portion forming the housing opening. Meanwhile, the other is provided on an end portion of the lid. For example, in the retaining mechanism, the engaged body includes a claw portion, and the claw portion climbs over the engaging body along with the turning operation by the hinge body, thereby making the claw portion lock to the engaging body at the closed position. That is, the engaging body and the engaged body continue to slide while pressing each other until reaching a locked state (that is, a fully engaged state).

Incidentally, the housing member may have a step at the housing opening depending on various conditions, such as the shape of the object to be housed, the shape and arrangement of peripheral components, and others. For example, in the housing member, when the housing opening has a first opening, and a second opening that projects more than the first opening, a first closing portion that closes the first opening and a second closing portion that closes the second opening are provided on the lid. Then, in this housing member, a portion between an edge portion forming the first opening and an end portion of the first closing portion or between an edge portion forming the second opening and an end portion of the second closing portion is coupled by the hinge body. Even when the housing opening has such a step, it is desirable that the housing member retain, in order to improve the closure of the housing chamber, a closed state of the first opening by the first closing portion and a closed state of the second opening by the second closing portion. Because of this, in this housing member, it is desirable that the retaining mechanism be provided on the first opening side and the second opening side. In this housing member, in the retaining mechanism on the opening side that does not have the hinge body, when viewed in the axial direction of the turning axis of the hinge body, the engaging body and the engaged body are arranged with a large offset from the turning axis of the hinge body, with respect to the retaining mechanism on the opening side that has the hinge body. The retaining mechanism on the opening side that has the hinge body can, even when it is of the form in which the engaging body and the engaged body exert the pressing force on each other until reaching the full engagement, make it fully engage along with the turning operation by the hinge body, by making the engaging body and the engaged body conform with the shape corresponding to the turning trace of the lid by the hinge body. However, because the retaining mechanism on the opening side that does not have the hinge body is in the offset arrangement as in the foregoing, it is difficult to make the engaging body and the engaged body conform with the shape corresponding to the turning trace of the lid by the hinge body, and thus it is difficult to make it fully engage along with the turning operation by the hinge body. Thus, in this housing member, it is difficult to make both retaining mechanisms fully engage along with the turning operation of the lid by the hinge body, and thus it is difficult to improve the closure of the housing chamber.

### SUMMARY OF THE INVENTION

Consequently, an object of the present invention is to provide a housing member that can improve the closure of the housing chamber.

In order to achieve the above mentioned object, a housing member according to one aspect of the present invention includes a housing body that houses at least a conductive member as an object to be housed via a housing opening including a plurality of openings forming a step; a lid that closes up the housing opening by closing portions for the respective openings; a hinge body that couples a reference-opening edge portion forming a reference opening out of the openings, to an end portion of a reference closing portion as the closing portion of the reference opening, and lets the lid turn with respect to the housing body between an opened position with respect to the housing opening and a closed position with respect to the housing opening; a first retaining mechanism that includes a first engaging body that is arranged between an offset opening in parallel with the reference opening out of the openings, and an offset closing portion as the closing portion closing up the offset opening, and is provided on one of a turning axis side of the hinge body in an offset-opening edge portion forming the offset opening and the turning axis side in an end portion of the offset closing portion, and a first engaged body provided on the other of the turning axis side, and that retains the lid to the housing body at the closed position with a relative turning operation between the housing body and the lid via the hinge body along with full engagement between the first engaging body and the first engaged body; and a second retaining mechanism that includes a second engaging body and a second engaged body arranged between the reference-opening edge portion and an end portion of the reference closing portion, and that retain the lid to the housing body at the closed position with full engagement between the second engaging body and the second engaged body along with a relative turning operation between the housing body and the lid via the hinge body, wherein the first engaging body and the first engaged body are formed such that no pressing force is exerted on the other until being fully engaged with each other.

According to another aspect of the present invention, in the housing member, it is desirable that the first engaging body and the first engaged body are formed so as to avoid coming in contact with each other until being fully engaged with each other.

According to still another aspect of the present invention, in the housing member, it is desirable that the first engaging body includes two leg portions that are spaced apart from each other and extend from one of the turning axis side in the offset-opening edge portion and the turning axis side in an end portion of the offset closing portion, and a coupling portion that connects end portions of the two leg portions on an extending direction side, and the first engaged body is a locking claw projecting from the other of the turning axis side in the offset-opening edge portion and the turning axis side in the end portion of the offset closing portion, and includes a claw portion that is made into a fully engaged state together with the first engaging body by being inserted into a void portion of the first engaging body including the two leg portions and the coupling portion and being locked to the coupling portion.

According to still another aspect of the present invention, in the housing member, it is desirable to further include a third retaining mechanism that retains the lid to the housing body at the closed position with a third engaging body and a third engaged body arranged between the reference-opening edge portion and an end portion of the reference closing portion and the third engaging body and the third engaged body being fully engaged along with a relative turning operation between the housing body and the lid via the hinge body, wherein the reference-opening edge portion includes an inner-side edge portion on the turning axis side to which the hinge body is coupled, and an outside edge portion that is arranged being spaced apart from the inner-side edge portion, the end portion of the reference closing portion includes an inner-side end portion on the turning axis side to which the hinge body is coupled, and an outside end portion that is arranged being spaced apart from the inner-side end portion, the second retaining mechanism is arranged between the inner-side edge portion and the inner-side end portion, and the third retaining mechanism is arranged between the outside edge portion and the outside end portion.

According to still another aspect of the present invention, in the housing member, it is desirable that the opening arranged at an innermost location, out of the openings, is set to as the reference opening.

According to still another aspect of the present invention, in the housing member, it is desirable that the conductive member is an electrical wire electrically coupled to one of two electrode terminals that a plurality of arrayed battery cells include and to a battery monitoring unit that monitors a battery status of the battery cells, and/or an electrical wire that electrically couples a temperature detecting device configured to detect temperature of the battery cells to the battery monitoring unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view partially illustrating a storage case according to an embodiment in a state that a lid is opened;

FIG. 2 is a perspective view partially illustrating the storage case in the embodiment in a state that the lid is opened;

FIG. 3 is a perspective view illustrating a battery module that is a mounting object of the housing case in the embodiment;

FIG. 4 is a perspective view partially illustrating a housing member in the embodiment in a state that the lid is opened;

FIG. 5 is a perspective view partially illustrating the housing member in the embodiment viewed from another angle in a state that the lid is opened;

FIG. 6 is a plan view partially illustrating the housing member in the embodiment in a state that the lid is opened;

FIG. 7 is a side view partially illustrating the housing member in the embodiment in a state that the lid is opened;

FIG. 8 is a perspective view partially illustrating the housing member in the embodiment in a state that the lid is closed;

FIG. 9 is a side view partially illustrating the housing member in the embodiment in a state that the lid is closed;

FIG. 10 is a side view partially illustrating the opposite side of the housing member in the embodiment in a state that the lid is closed;

FIG. 11 is a side view partially illustrating the housing member in the embodiment in a state that the lid is in the middle of being closed;

FIG. 12 is a cross-sectional view at the line X1-X1 in FIG. 7;

FIG. 13 is a cross-sectional view at the line X2-X2 in FIG. 11; and

FIG. 14 is a cross-sectional view at the line X3-X3 in FIG. 9.

### DETAILED DESCRIPTION OF THE PREFERRED EMBODIMENT

The following describes an exemplary embodiment of a housing member according to the present invention in detail based on the accompanying drawings. The invention, however, is not intended to be limited by the embodiment.

### Embodiment

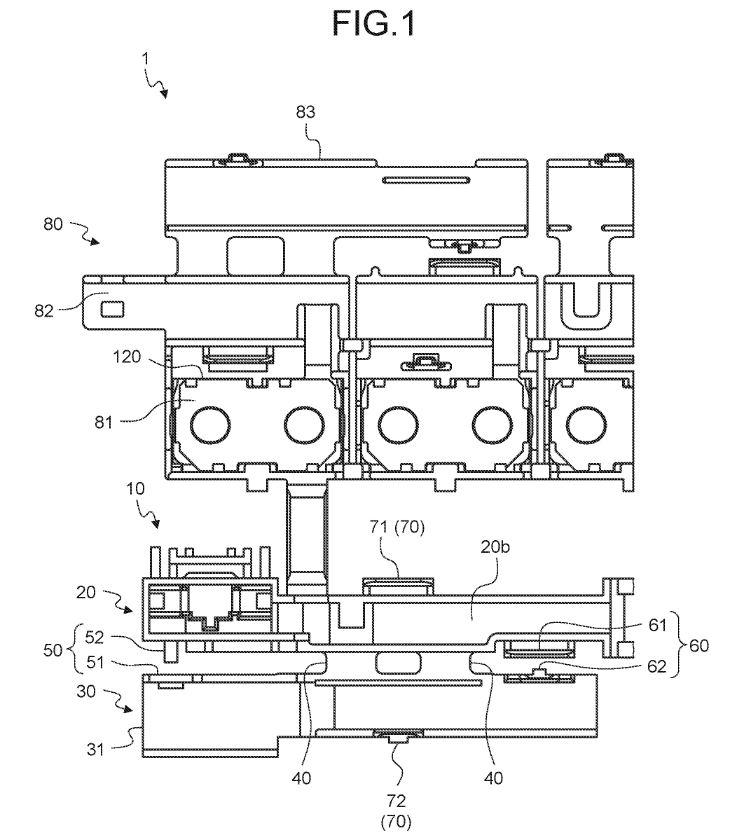

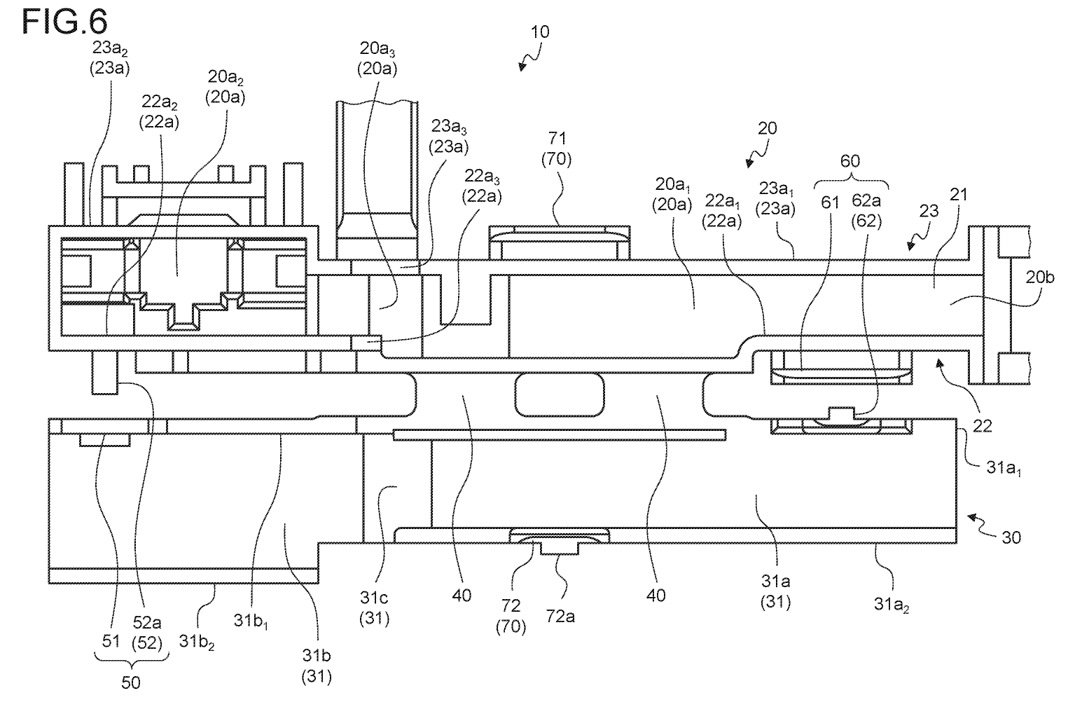

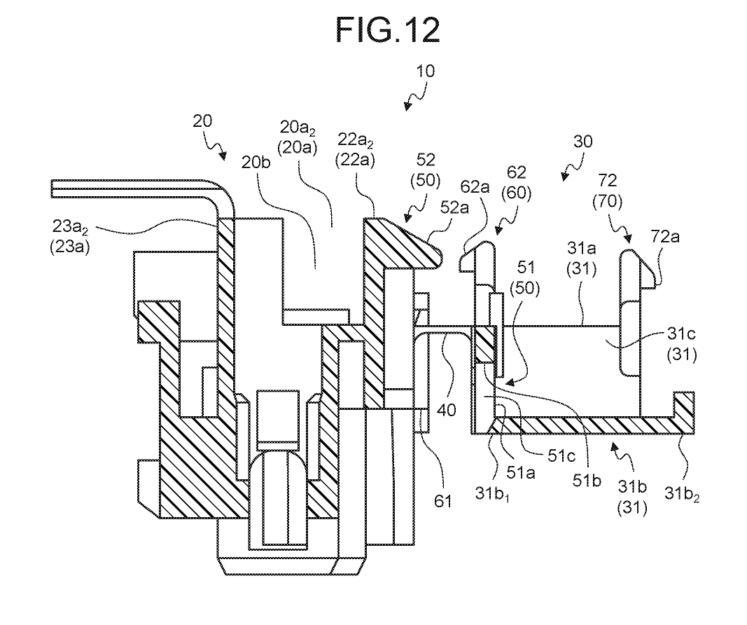

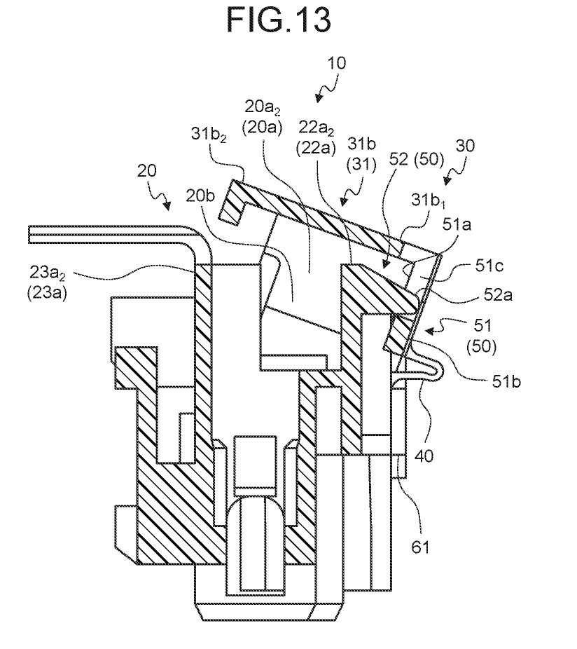

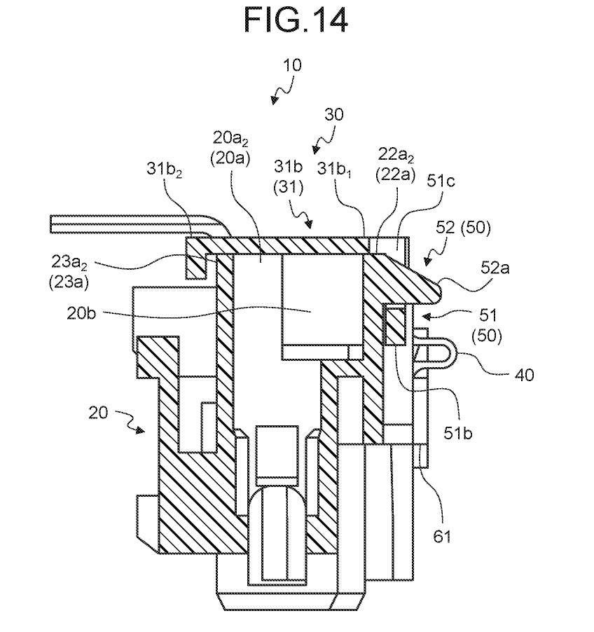

One embodiment of the housing member in the invention will be described based on FIGS. 1 to 14.

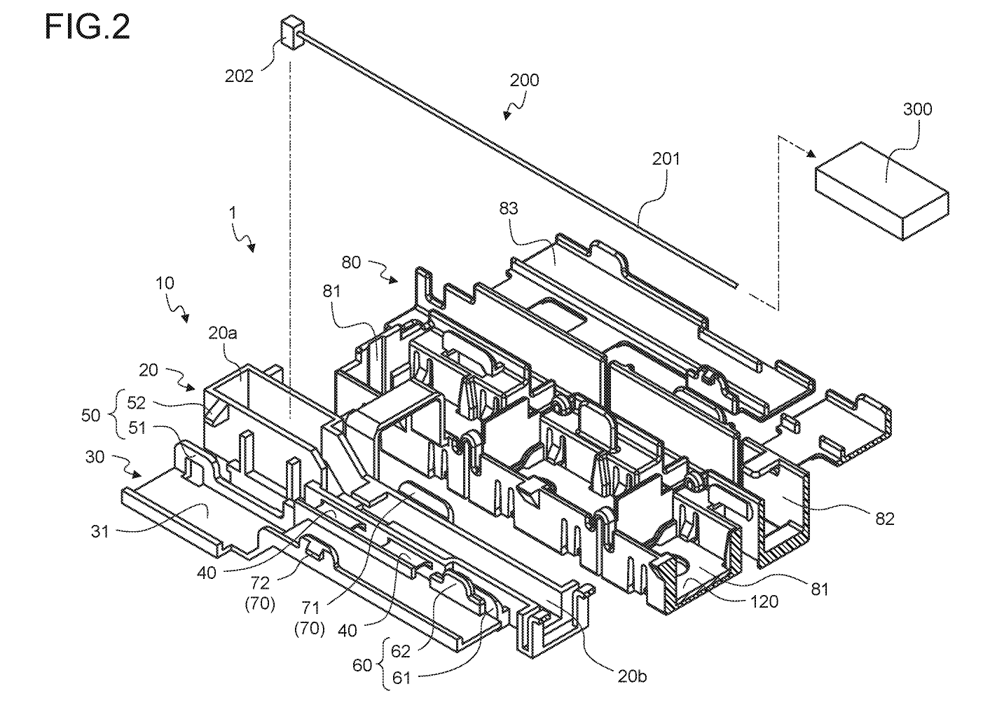

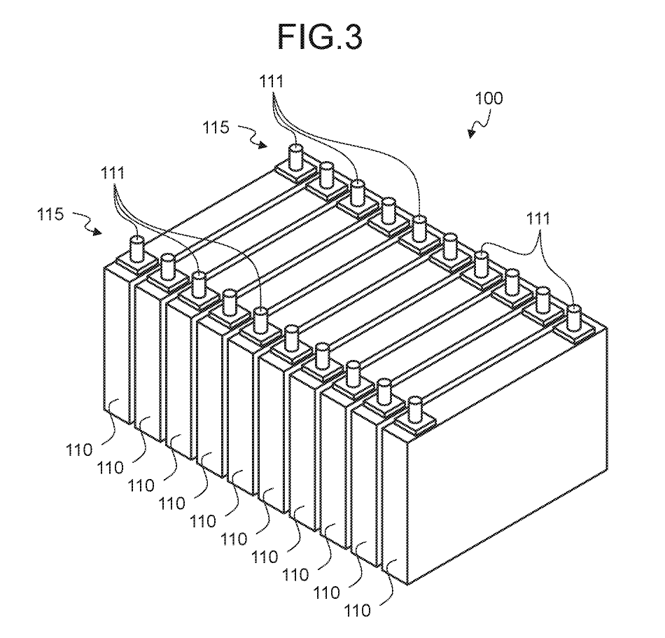

The reference symbols 1 and 10 in FIGS. 1 and 2 represent a storage case and a housing member, respectively, in the embodiment. The housing member 10 houses at least a conductive member as an object to be housed, and constitutes the storage case 1. The storage case 1 is exemplified as, by setting a battery module 100 illustrated in FIG. 3 as a mounting object, housing a conductive module 200 (FIG. 2) for obtaining battery information on the battery module 100. The storage case 1 constitutes a battery pack together with the battery module 100 and the conductive module 200. First, the battery module 100 and the conductive module 200 will be described simply.

The battery module 100 is installed on a vehicle such as an electric vehicle and a hybrid vehicle as a battery pack, and includes a plurality of battery cells 110 (FIG. 3). In the battery module 100, each of the battery cells 110 is arrayed continuously in a state that any one of electrode terminals 111 of each of the battery cells 110 is lined up and the other of the electrode terminals 111 is also lined up. In this battery module 100, the electrode terminals 111 are lined up at two places and, at each place, form electrode terminal groups 115 by a plurality of electrode terminals 111. In this battery module 100, the array direction of each of the battery cells 110 (hereinafter referred to as “cell array direction”) and the array direction of each of the electrode terminals 111 in the respective electrode terminal groups 115 (hereinafter referred to as “terminal array direction”) match. The battery cells 110, although not depicted, are kept in an arrayed state via a cell housing member that houses the respective battery cells, a retaining structure that houses the respective battery cells, and others.

In this battery module 100, for each of the electrode terminal groups 115, two electrode terminals 111 adjacent in the cell array direction are coupled with a conductive bus bar 120 (FIGS. 1 and 2). The bus bar 120 is formed of a conductive material such as metal and is provided for each combination of the two adjacent electrode terminals 111. The two adjacent electrode terminals 111 are physically and electrically coupled to the bus bar 120 for each combination thereof. The bus bar 120 of this example is formed in a rectangular flat-plate shape. For example, when the electrode terminals 111 are plate-like, the bus bar 120 is physically and electrically coupled to the electrode terminals 111 by welding (laser welding and others). Meanwhile, when the electrode terminals 111 are electrode poles, by forming through-holes on the bus bar 120 into which the respective electrode terminals 111 are inserted and by fixing this bus bar 120 to the electrode terminals 111 by screws, a portion between each other is physically and electrically coupled. In this battery module 100, there are two electrode terminals 111 that are not coupled with the bus bar 120, and one of those is what is called a total positive electrode and the other is what is called a total negative electrode.

The conductive module 200 electrically couples the battery cell 110 side and a battery monitoring unit 300 (FIG. 2). The battery monitoring unit 300 is a device that monitors a battery status of the battery cells 110, and is installed in the vehicle body and the like. The conductive module 200 is disposed on at least one of the two electrode terminal groups 115, for example. The conductive module 200 at least includes a conductive member 201.

The conductive member 201 is conductive members that each are electrically coupled to one of the two electrode terminals 111 of a plurality of arrayed battery cells 110 and to the battery monitoring unit 300, and/or is conductive members that electrically couple an electronic component 202 to the battery monitoring unit 300. The former of the conductive member 201, by directly or indirectly attaching it to the electrode terminal 111, electrically couples to the electrode terminal 111. For example, this conductive member 201 couples to the electrode terminal 111 via the bus bar 120. In this case, the bus bar 120 may be considered as one of the constituents of the conductive module 200. Meanwhile, the later of the conductive member 201 is physically and electrically coupled to the electronic component 202 and constitutes the conductive module 200 together with the electronic component 202. As for the electronic component 202, a temperature detecting device is conceivable as an applicable object. The temperature detecting device is a device that detects the temperature of at least one of a plurality of arrayed battery cells 110. For example, the temperature detecting device is a temperature sensor such as a thermistor that detects the temperature of the battery cells 110, and is provided for each of the battery cells 110 that is an object of measurement.

This conductive member 201 extends in the terminal array direction with the conductive module 200 mounted on the battery module 100. As for the conductive member 201 of this example, an electrical wire for which a core wire as a conductive material is covered with a covering as an insulative material is used. In the conductive module 200 of this example, a plurality of conductive members 201 are provided, and the electronic component 202 is coupled to each. In the housing member 10, the combinations of the conductive member 201 and the electronic component 202 are put together and housed.

Next, the storage case 1 will be described.

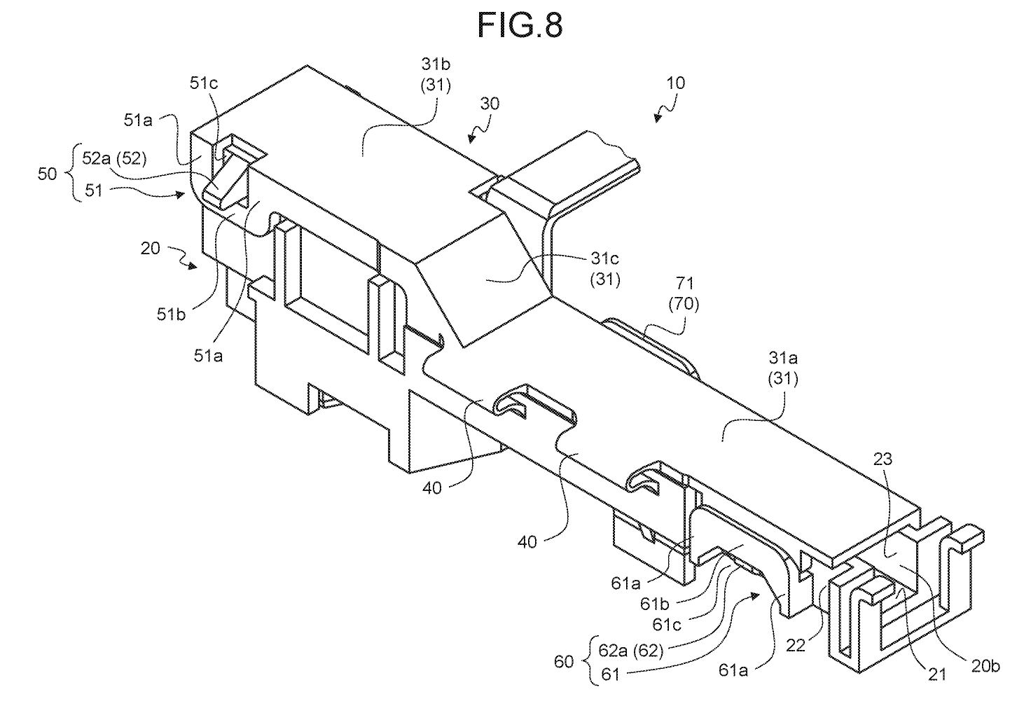

The storage case 1 includes the housing member 10 that houses an object to be housed. The housing member 10 is shaped with an insulative material such as synthetic resin. The housing member 10 includes a housing body 20 that houses an object to be housed via a housing opening 20a, a lid 30 that closes up the housing opening 20a, and a hinge body 40 that lets the lid 30 turn with respect to the housing body 20 (FIGS. 1, 2, and 4 to 7). The hinge body 40 lets the lid 30 turn with respect to the housing body 20 between an opened position with respect to the housing opening 20a (FIGS. 1, 2, and 4 to 7) and a closed position with respect to the housing opening 20a (FIGS. 8 to 10). The housing member 10 includes first to third retaining mechanisms 50, 60, and 70 for making the housing body 20 retain the lid 30 at the closed position. Moreover, the housing member 10 of this example further includes a retaining body 80 that retains the bus bars 120 (FIGS. 1 and 2). The storage case 1 includes a plurality of housing members 10 arrayed along the terminal array direction, and a portion between two housing members 10 to be the objects of coupling is connected by a coupling structure (depiction omitted). The storage case 1 is provided, although not depicted, with a mounting mechanism between the storage case 1 and the foregoing retaining structure, for example, and is mounted on the battery module 100 via the retaining structure.

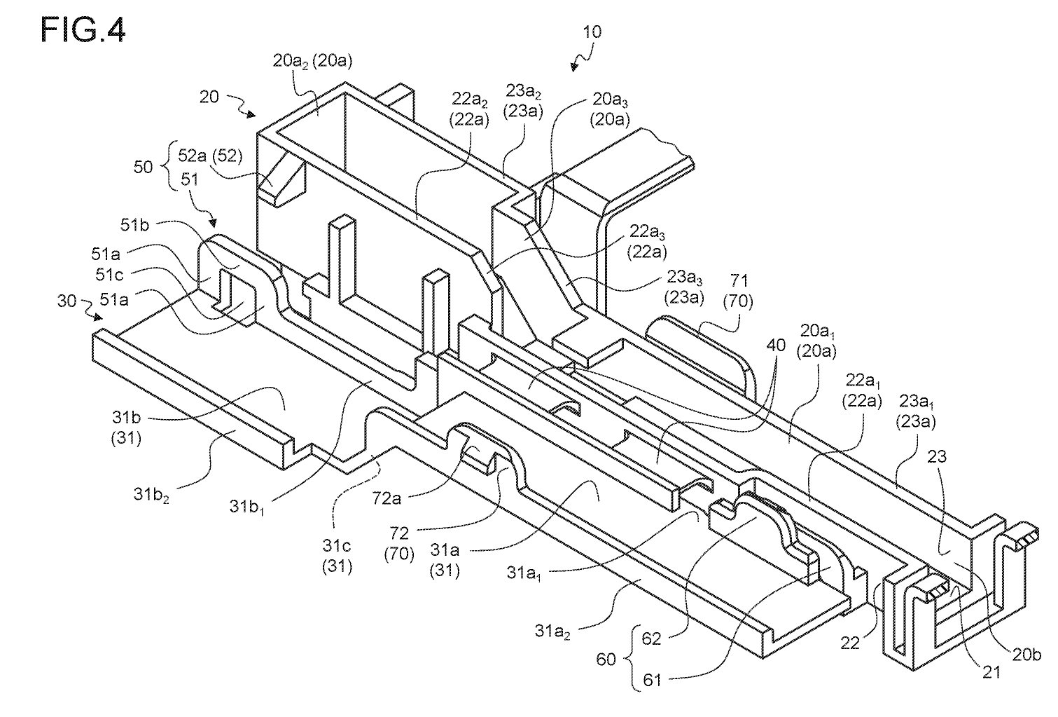

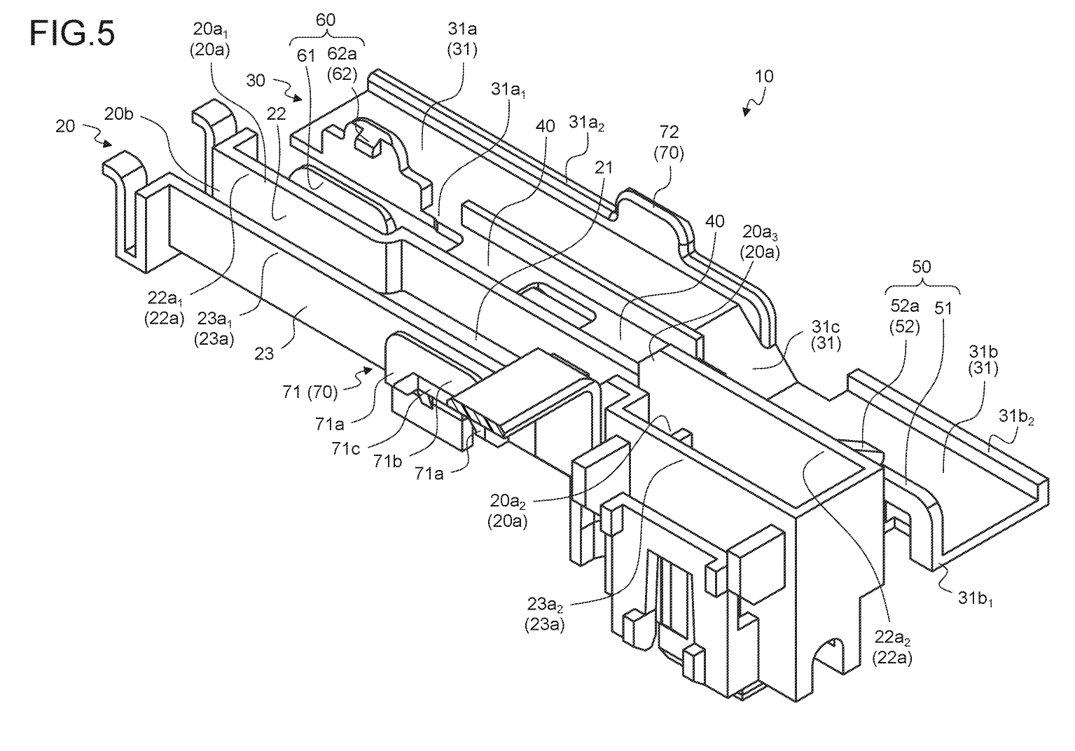

The housing body 20 includes a bottom portion 21, and first and second standing wall portions 22 and 23 that are provided standing from the bottom portion 21 and being spaced apart from each other (FIGS. 4 to 6). In the housing body 20, a space surrounded by the bottom portion 21, the first standing wall portion 22, and the second standing wall portion 23 constitute a housing chamber 20b, and the housing chamber 20b houses an object to be housed. The housing body 20 extends the bottom portion 21, the first standing wall portion 22, and the second standing wall portion 23 in the terminal array direction. In the housing body 20, the bottom portion 21 or the bottom portion 21 side is placed on the battery module 100. The first standing wall portion 22 and the second standing wall portion 23, in a state of being placed, make surfaces face each other in the direction orthogonal to the terminal array direction, and are vertically provided from both end portions of the bottom portion 21 in the orthogonal direction. In the housing body 20 of this example, the bottom portion 21, the first standing wall portion 22, and the second standing wall portion 23 are formed in a substantially rectangular plate-like shape, and are shaped such that an orthogonal cross-section with respect to the terminal array direction is U-shaped. In the housing body 20, an opening between free ends 22a and 23a (free ends on the opposite side of the bottom portion 21 side) of the first standing wall portion 22 and the second standing wall portion 23, respectively, is used as the housing opening 20a (FIGS. 4 and 5). The first standing wall portion 22 and the second standing wall portion 23 each have flexibility that bending with the bottom portion 21 side as a fulcrum is possible. Thus, in the housing body 20, by exerting an external force on the first standing wall portion 22 and the second standing wall portion 23, an interval between the free end 22a of the first standing wall portion 22 and the free end 23a of the second standing wall portion 23 can be changed.

The housing body 20 has a step at the housing opening 20a in the terminal array direction. The housing opening 20a includes a plurality of openings that form the step. The housing opening 20a may have one step or a plurality of steps. The housing opening 20a of this example includes a first opening 20a₁, a second opening 20a₂ that projects more than the first opening 20a₁ when viewed from the bottom portion 21 side, and a coupling opening 20a₃ that connects the first opening 20a₁ and the second opening 20a₂, and the step is of one step (FIGS. 4 and 5). The first opening 20a₁ and the second opening 20a₂ are openings that are parallel to the plane (bottom surface) of the bottom portion 21, and are formed in rectangular shapes. Meanwhile, the coupling opening 20a₃ of this example is inclined with respect to the plane of the bottom portion 21, and is formed in a rectangular shape.

The free end 22a of the first standing wall portion 22 and the free end 23a of the second standing wall portion 23 each have a step that corresponds to the locations of the respective openings 20a₁ to 20a₃. The free end 22a has first to third free ends 22a₁ to 22a₃. The free end 23a has first to third free ends 23a₁ to 23a₃. The first free end 22a₁ of the first standing wall portion 22 and the first free end 23a₁ of the second standing wall portion 23 face each other in the direction orthogonal to the bottom surface of the bottom portion 21 and the direction orthogonal to the terminal array direction, and form the first opening 20a₁. The second free end 22a₂ of the first standing wall portion 22 and the second free end 23a₂ of the second standing wall portion 23 face each other in the orthogonal direction thereof, and form the second opening 20a₂. The third free end 22a₃ of the first standing wall portion 22 and the third free end 23a₃ of the second standing wall portion 23 face each other in the orthogonal direction thereof, and form the coupling opening 20a₃.

As for the bottom surface of the bottom portion 21 in the housing chamber 20b, when placed on the battery module 100, the interval with the plane (a virtual plane made of a plurality of arrayed battery cells 110) of the battery module 100 may be constant in the terminal array direction, or may be changed in the terminal array direction (having a step as with the housing opening 20a). For example, when the bottom surface of the bottom portion 21 is constant as with the former one, in the housing chamber 20b, the depth of the portion that the first opening 20a₁ is located is shallower than the depth of the portion that the second opening 20a₂ is located. Meanwhile, when keeping the depth of the housing chamber 20b constant in the terminal array direction is desired, the same step as that of the housing opening 20a, which corresponds to the locations of the respective openings 20a₁ to 20a₃, only needs to be provided on the bottom surface of the bottom portion 21, for example. Here, the former one is exemplified, and the electronic component (temperature detecting device) 202 is housed at the location of the second opening 20a₂ in the housing chamber 20b.

The lid 30 includes a lid portion 31 of a shape corresponding to the shape of the housing opening 20a (FIGS. 1, 2, and 4 to 6). The lid portion 31 includes closing portions for the respective openings 20a₁ to 20a₃. The lid portion 31 of this example includes a first closing portion 31a that closes up the first opening 20a₁, a second closing portion 31b that closes up the second opening 20a₂, and a coupling closing portion 31c that closes up the coupling opening 20a₃. The first closing portion 31a is formed in a rectangular plate-like shape corresponding to the shape of the first opening 20a₁, and includes, at the closed position, a first end portion 31a₁ adjacent to the first free end 22a₁ of the first standing wall portion 22, and a second end portion 31a₂ adjacent to the first free end 23a₁ of the second standing wall portion 23. The second closing portion 31b is formed in a rectangular plate-like shape corresponding to the shape of the second opening 20a₂, and includes, at the closed position, a first end portion 31b₁ adjacent to the second free end 22a₂ of the first standing wall portion 22, and a second end portion 31b₂ adjacent to the second free end 23a₂ of the second standing wall portion 23. The coupling closing portion 31c is formed in a rectangular plate-like shape corresponding to the shape and incline of the coupling opening 20a₃.

The hinge body 40 sets one of a plurality of openings 20a₁ to 20a₃ in the housing opening 20a as a reference opening, and is arranged between the reference opening and a closing portion of the lid portion 31 that closes up the reference opening (hereinafter referred to as “reference closing portion”). This hinge body 40 enables, by coupling the edge portion forming the reference opening (hereinafter referred to as “reference-opening edge portion”), and the end portion of the reference closing portion thereof, a relative turning operation between the housing body 20 and the lid 30. In this example, out of the openings 20a₁ to 20a₃, the one that is arranged at the innermost location (that is, closest to the bottom portion 21 side) is set as the reference opening. Thus, the first opening 20a₁ is set as the reference opening and the first closing portion 31a is set as the reference closing portion (FIGS. 4 and 5). Accordingly, in the following description, the first opening 20a₁ may be referred to as the reference opening 20a₁ and the first closing portion 31a may be referred to as the reference closing portion 31a. In setting, it is desirable that the coupling opening 20a₃ and the coupling closing portion 31c be excluded from the setting objects of the reference opening.

As for the reference opening 20a₁, the free end 22a (the first free end 22a₁) of the first standing wall portion 22 and the free end 23a (the first free end 23a₁) of the second standing wall portion 23 serve as the reference-opening edge portions. The hinge body 40 is coupled to one of the first free end 22a₁ and the first free end 23a₁. Because of this, the respective reference-opening edge portions are separated into an inner-side edge portion on the turning axis side of the hinge body 40 to which the hinge body 40 is coupled and an outside edge portion that is arranged being spaced apart from the inner-side edge portion. In this example, the first free end 22a₁ of the first standing wall portion 22 and the one end of the hinge body 40 bordering the turning axis are coupled, and thus the first free end 22a₁ becomes the inner-side edge portion and the first free end 23a₁ of the second standing wall portion 23 becomes the outside edge portion.

Meanwhile, the reference closing portion 31a that closes up the reference opening 20a₁ includes, as the end portions thereof, the inner-side end portion on the turning axis side to which the hinge body 40 is coupled, and the outside end portion that is arranged being spaced apart from the inner-side end portion. The hinge body 40 of this example couples the other end bordering the turning axis to the first end portion 31a₁ that is adjacent to the first free end 22a₁ at the closed position. Because of this, the first end portion 31a₁ becomes the inner-side end portion and the second end portion 31a₂ becomes the outside end portion.

It can be said that the second opening 20a₂ is a parallel opening that is offset in the depth direction of the housing chamber 20b with respect to the reference opening 20a₁. Thus, the second opening 20a₂ may be referred to as the offset opening 20a₂. In the same manner, it can be said that the second closing portion 31b is a parallel closing portion that is offset with respect to the reference closing portion 31a. Thus, the second closing portion 31b may be referred to as the offset closing portion 31b. In the housing opening 20a, when there are three or more parallel openings, such as the first opening 20a₁ and the second opening 20a₂, which are offset from one another in the depth direction of the housing chamber 20b, one of the openings is set as the reference opening, and all remaining openings are set as the offset openings. In this case, the lid portion 31 of the lid 30 also has three or more parallel closing portions that are offset to one another, and thus the closing portion that closes up the reference opening is set as the reference closing portion, and the respective closing portions that close up the respective offset openings are set as the offset closing portions.

The hinge body 40 is exemplified as being formed together with the housing body 20 and the lid 30 and is what is called a living hinge having flexibility of thin and rectangular. Thus, the hinge body 40 of this example is to bend in closing up the housing opening 20a with the lid 30. In the hinge body 40, the central axis of the rotation in the bending between the housing body 20 and the lid 30 becomes the turning axis. The hinge body 40 places the housing body 20 and the lid 30 in juxtaposition at the time of the opened position, for example, and closes up the housing opening 20a of the housing body 20 with the lid 30 at the time of the closed position.

The housing member 10 is arranged between the housing body 20 and the lid 30, and includes a retaining mechanism that retains the lid 30 to the housing body 20 at the closed position in which the housing opening 20a is closed up. As for the retaining mechanism, provided are at least one each of a retaining mechanism provided on the reference opening 20a₁ side that includes the hinge body 40 (hereinafter referred to as “reference retaining mechanism”) and of a retaining mechanism provided on the offset opening 20a₂ side that is offset with respect to the reference opening 20a₁ (hereinafter referred to as “offset retaining mechanism”). In this example, as in the foregoing, the first to the third retaining mechanisms 50, 60, and 70 are provided. The first retaining mechanism 50 is provided as the offset retaining mechanism, and is arranged between the offset opening 20a₂ and the offset closing portion 31b (FIGS. 1, 2, and 4 to 6). Meanwhile, the second retaining mechanism 60 and the third retaining mechanism 70 are provided as the reference retaining mechanisms, and each are arranged between the reference opening 20a₁ and the reference closing portion 31a.

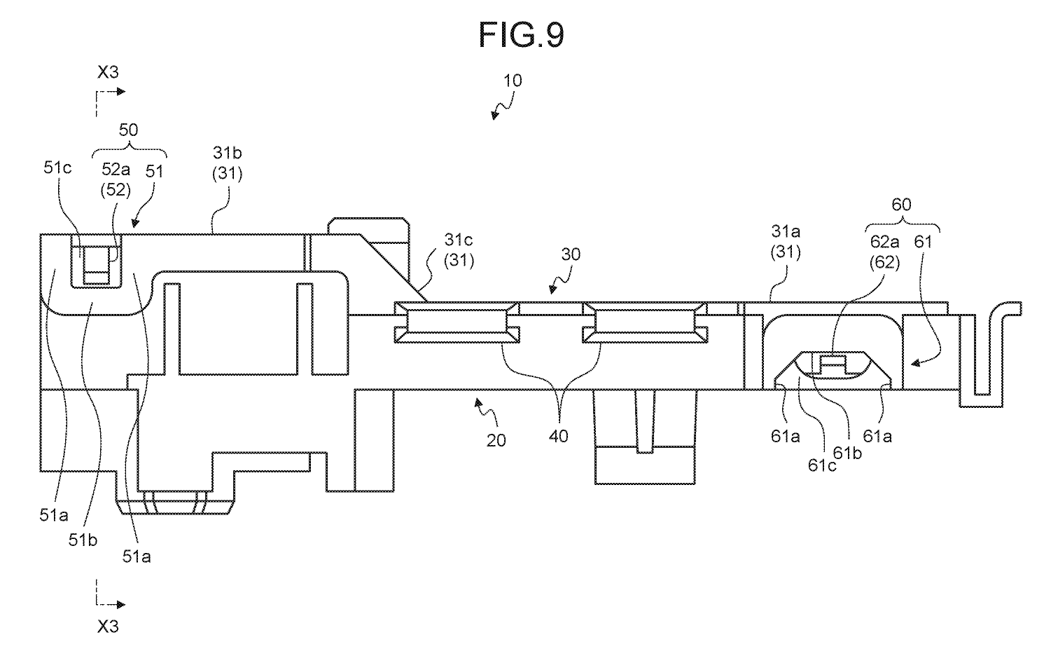

The first retaining mechanism 50 includes a first engaging body 51 provided on one of the housing body 20 and the lid 30, and a first engaged body 52 provided on the other (FIGS. 1, 2, and 4 to 9). The first engaging body 51 and the first engaged body 52 are formed such that, by being fully engaged with each other, the lid 30 is retained to the housing body 20 at the closed position (FIGS. 8 and 9). The first retaining mechanism 50 makes the housing body 20 retain the lid 30 at the closed position, by making the first engaging body 51 and the first engaged body 52 fully engage along with the relative turning operation between the housing body 20 and the lid 30 via the hinge body 40 and maintain the closed state of the offset opening 20a₂ by the offset closing portion 31b. The first engaging body 51 is provided on one of the turning axis side of the hinge body 40 in the edge portion forming the offset opening 20a₂ (hereinafter referred to as “offset-opening edge portion”), and the turning axis side of the hinge body 40 in the end portion of the offset closing portion 31b. Then, the first engaged body 52 is provided on the other.

As for the offset opening 20a₂, it includes, as the offset-opening edge portions, the free end 22a (the second free end 22a₂) of the first standing wall portion 22 and the free end 23a (the second free end 23a₂) of the second standing wall portion 23 (FIGS. 4 to 6). As for the offset closing portion 31b, it includes, as the end portions thereof, the first end portion 31b₁ that is adjacent to the second free end 22a₂ at the closed position and the second end portion 31b₂ that is adjacent to the second free end 23a₂. Thus, the first retaining mechanism 50 is provided on one of a portion between the second free end 22a₂ and the first end portion 31b₁ and a portion between the second free end 23a₂ and the second end portion 31b₂. In this example, however, because the hinge body 40 is coupled to the free end 22a (the first free end 22a₁) of the first standing wall portion 22 and to the first end portion 31a₁ of the reference closing portion 31a, the first retaining mechanism 50 is arranged between the second free end 22a₂ of the first standing wall portion 22 and the first end portion 31b₁ of the offset closing portion 31b. In the first retaining mechanism 50, the first engaging body 51 is provided on one of the second free end 22a₂ and the first end portion 31b₁ and the first engaged body 52 is provided on the other. Here, the first engaging body 51 is provided on the first end portion 31b₁ and the first engaged body 52 is provided on the second free end 22a₂.

The first retaining mechanism 50 is configured as a locking mechanism that makes the projecting portion of the first engaged body 52 lock to the first engaging body 51 at the closed position. For example, the first engaging body 51 is formed in a U-shape that has two leg portions 51a being spaced apart from each other and extending from the first end portion 31b₁ and a coupling portion 51b connecting the end portions of the extending direction side of the two leg portions 51a (FIG. 4). The leg portions 51a each extend so as to face in the direction orthogonal to the plane of the lid portion 31 and on the housing body 20 side at the closed position. The first engaging body 51 includes a rectangular void portion 51c formed by the two leg portions 51a and the coupling portion 51b. Meanwhile, the first engaged body 52 is formed as a locking claw projecting from the second free end 22a₂, and is locked to the coupling portion 51b in the void portion 51c of the first engaging body 51. The first engaged body 52 includes a claw portion 52a that becomes a fully engaged state together with the first engaging body 51, by being inserted into the void portion 51c of the first engaging body 51 and being in a state possible to lock to the coupling portion 51b (FIGS. 4 to 6). The claw portion 52a projects from the second free end 22a₂ so as to face the lid 30 side at the opened position.

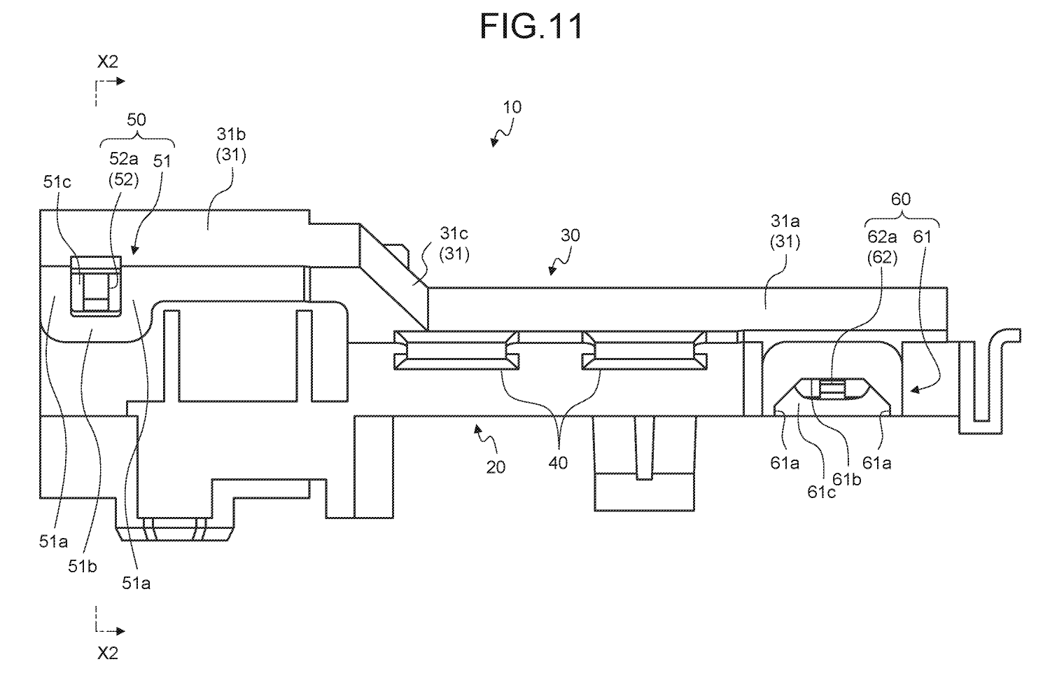

The first engaging body 51 and the first engaged body 52 are formed such that no pressing force is exerted on the other until being fully engaged with each other. For example, the first engaging body 51 and the first engaged body 52 are formed so as to avoid coming in contact with each other until being fully engaged with each other (FIGS. 11 to 14). Thus, the first engaging body 51 and the first engaged body 52 are formed such that, while coming closer to each other along with the relative turning operation between the housing body 20 and the lid 30 via the hinge body 40, there is no contact between each other until the claw portion 52a is inserted into the void portion 51c of the first engaging body 51, and such that, when the turning operation is ended (that is, at least the second retaining mechanism 60 is in a fully engaged state) after the insertion, the first engaging body 51 and the first engaged body 52 are in a fully engaged state with each other.

As just described, the first engaging body 51 and the first engaged body 52 may avoid coming in contact with each other until being fully engaged with each other. However, they may come in contact with each other within a range of exerting no pressing force on the other. For example, the first engaging body 51 and the first engaged body 52 may be formed so as to slide each other within a range of exerting no pressing force on the other until being fully engaged with each other.

The second retaining mechanism 60 includes a second engaging body 61 that is provided on one of the housing body 20 and the lid 30, and a second engaged body 62 that is provided on the other (FIGS. 1, 2, and 4 to 9). The second engaging body 61 and the second engaged body 62 are formed such that, by being fully engaged with each other, the lid 30 is retained to the housing body 20 at the closed position (FIGS. 8 and 9). The second retaining mechanism 60 makes the housing body 20 retain the lid 30 at the closed position, by making the second engaging body 61 and the second engaged body 62 fully engage along with the relative turning operation between the housing body 20 and the lid 30 via the hinge body 40 and maintain the closed state of the reference opening 20a₁ by the reference closing portion 31a. In the second retaining mechanism 60, between the reference-opening edge portion and the end portion of the reference closing portion 31a, the second engaging body 61 and the second engaged body 62 are each arranged.

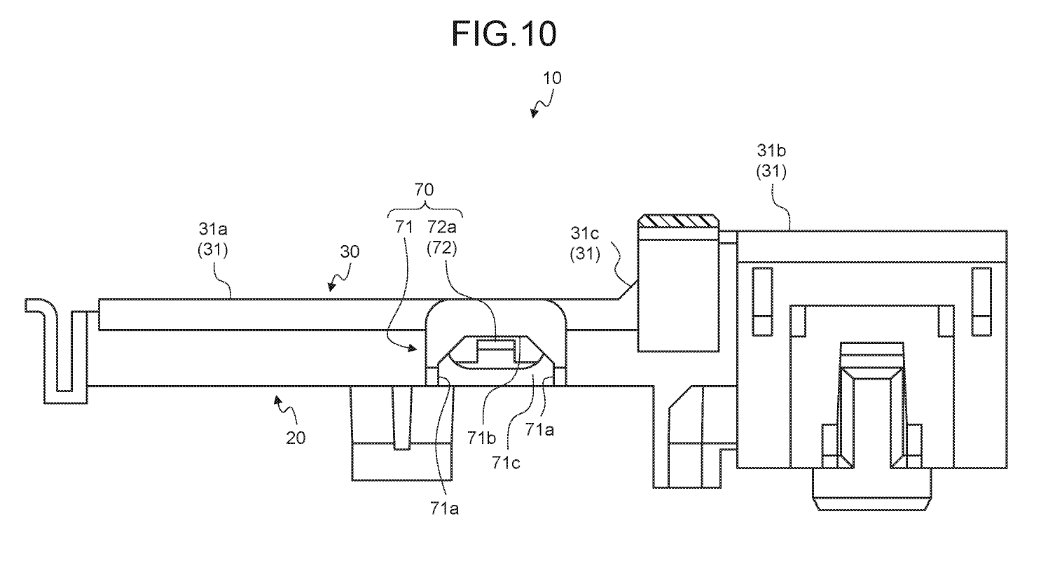

As with the second retaining mechanism 60, the third retaining mechanism 70 includes a third engaging body 71 that is provided on one of the housing body 20 and the lid 30, and a third engaged body 72 that is provided on the other (FIGS. 1, 2, 4 to 6, and 10). The third engaging body 71 and the third engaged body 72 are formed such that, by being fully engaged with each other, the lid 30 is retained to the housing body 20 at the closed position (FIG. 10). The third retaining mechanism 70 makes the housing body 20 retain the lid 30 at the closed position, by making the third engaging body 71 and the third engaged body 72 fully engage along with the relative turning operation between the housing body 20 and the lid 30 via the hinge body 40 and maintain the closed state of the reference opening 20a₁ by the reference closing portion 31a. In the third retaining mechanism 70, between the reference-opening edge portion and the end portion of the reference closing portion 31a, the third engaging body 71 and the third engaged body 72 are each arranged.

Specifically, the second retaining mechanism 60 and the third retaining mechanism 70 are arranged such that one of them is arranged between the inner-side edge portion (the first free end 22a₁) in the reference-opening edge portion (the first free end 22a₁ of the first standing wall portion 22 and the first free end 23a₁ of the second standing wall portion 23) and the inner-side end portion (the first end portion 31a₁) in the end portion (the first end portion 31a₁ and the second end portion 31a₂) of the reference closing portion 31a, while the other is arranged between the outside edge portion (the first free end 23a₁) in the reference-opening edge portion and the outside end portion (the second end portion 31a₂) in the end portion of the reference closing portion 31a. Here, the second retaining mechanism 60 is arranged between the inner-side edge portion (the first free end 22a₁) and the inner-side end portion (the first end portion 31a₁), and the third retaining mechanism 70 is arranged between the outside edge portion (the first free end 23a₁) and the outside end portion (the second end portion 31a₂).

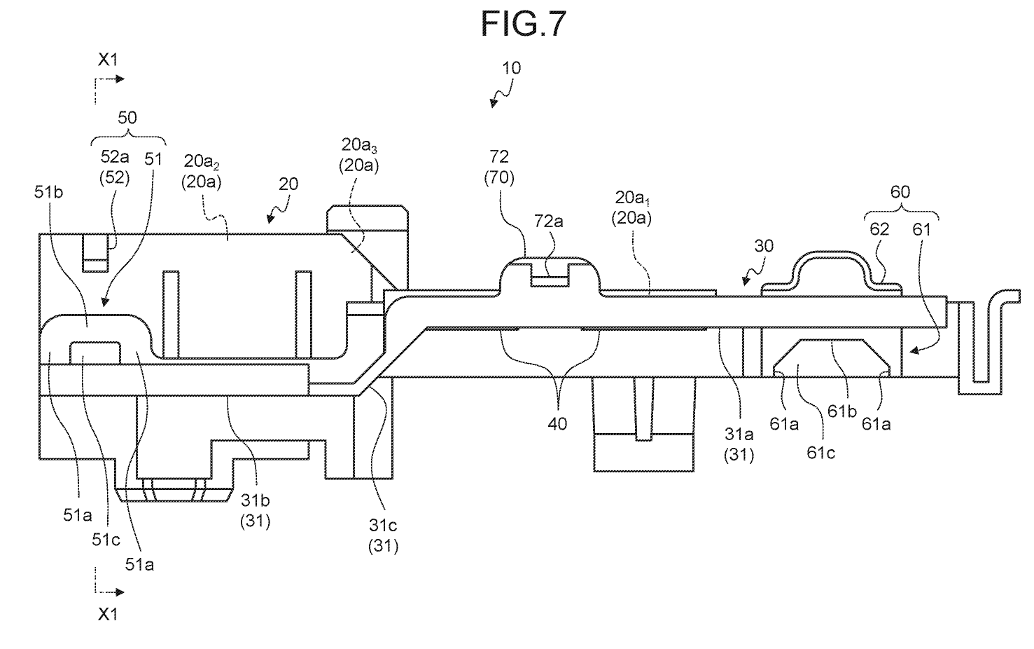

In the second retaining mechanism 60, the second engaging body 61 is provided on one of the inner-side edge portion (the first free end 22a₁) or its vicinity and the inner-side end portion (the first end portion 31a₁), and the second engaged body 62 is provided on the other. The second retaining mechanism 60 of this example is configured as a locking mechanism that makes the projecting portion of the second engaged body 62 lock to the second engaging body 61 at the closed position. However, the second engaging body 61 and the second engaged body 62 may exert pressing force on the other in the course of becoming fully engaged with each other. Here, the second engaging body 61 is provided near the inner-side edge portion (the first free end 22a₁) and the second engaged body 62 is provided at the inner-side end portion (the first end portion 31a₁). For example, the second engaging body 61 is formed in a U-shape that has two leg portions 61a being spaced apart from each other and extending and a coupling portion 61b connecting the end portions of the extending direction side of the two leg portions 61a (FIGS. 7 and 8). The second engaging body 61 includes a rectangular void portion 61c formed by the two leg portions 61a and the coupling portion 61b. In the second engaging body 61, the coupling portion 61b is arranged on the outside of the housing chamber 20b and near the inner-side edge portion (the first free end 22a₁), and the two leg portions 61a having flexibility extend toward the reference opening 20a₁ side from the bottom portion 21 side. The second engaging body 61 is, with respect to the outer wall surface of the first standing wall portion 22, juxtaposed in parallel being spaced apart in such a degree that the second engaged body 62 can be inserted. Meanwhile, the second engaged body 62 is formed as a locking claw projecting from the inner-side end portion (the first end portion 31a₁), and is locked to the coupling portion 61b in the void portion 61c of the second engaging body 61. The second engaged body 62 includes a claw portion 62a that becomes a fully engaged state together with the second engaging body 61, by being inserted into the void portion 61c of the second engaging body 61 and being in a state possible to lock to the coupling portion 61b (FIGS. 5, 6, and 9).

In the third retaining mechanism 70, the third engaging body 71 is provided on one of the outside edge portion (the first free end 23a₁) or its vicinity and the outside end portion (the second end portion 31a₂), and the third engaged body 72 is provided on the other. The third retaining mechanism 70 of this example is configured as a locking mechanism that makes the projecting portion of the third engaged body 72 lock to the third engaging body 71 at the closed position. However, the third engaging body 71 and the third engaged body 72 may exert pressing force on the other in the course of becoming fully engaged with each other. Here, the third engaging body 71 is provided near the outside edge portion (the first free end 23a₁) and the third engaged body 72 is provided at the outside end portion (the second end portion 31a₂). For example, the third engaging body 71 is formed in a U-shape that has two leg portions 71a being spaced apart from each other and extending and a coupling portion 71b connecting the end portions of the extending direction side of the two leg portions 71a (FIG. 5). The third engaging body 71 includes a rectangular void portion 71c formed by the two leg portions 71a and the coupling portion 71b. In the third engaging body 71, the coupling portion 71b is arranged on the outside of the housing chamber 20b and near the outside edge portion (the first free end 23a₁), and the two leg portions 71a having flexibility extend toward the reference opening 20a₁ side from the bottom portion 21 side. The third engaging body 71 is, with respect to the outer wall surface of the first standing wall portion 22, juxtaposed in parallel being spaced apart in such a degree that the third engaged body 72 can be inserted. Meanwhile, the third engaged body 72 is formed as a locking claw projecting from the outside end portion (the second end portion 31a₂), and is locked to the coupling portion 71b in the void portion 71c of the third engaging body 71. The third engaged body 72 includes a claw portion 72a that becomes a fully engaged state together with the third engaging body 71, by being inserted into the void portion 71c of the third engaging body 71 and being in a state possible to lock to the coupling portion 71b (FIGS. 4, 6, and 10).

In the housing member 10, along with the relative turning operation between the housing body 20 and the lid 30 via the hinge body 40, the second retaining mechanism 60 and the third retaining mechanism 70 as the reference retaining mechanisms are fully engaged. At that time, in the first retaining mechanism 50, although the first engaging body 51 and the first engaged body 52 come closer along with the turning operation, it is avoided that the pressing force is exerted on the other until being fully engaged with each other, and when at least the second retaining mechanism 60 is made into a fully engaged state (that is, when the inner-side edge portion (the first free end 22a₁) and the inner-side end portion (the first end portion 31a₁) are brought into contact at the closed position), the first engaging body 51 and the first engaged body 52 are made into a fully engaged state. In other words, in the housing member 10, in viewing in the direction orthogonal to the turning axis of the hinge body 40, although the first retaining mechanism 50 is offset larger than the second retaining mechanism 60, the first to the third retaining mechanisms 50, 60, and 70 can be all fully engaged, without defying the turning trace of the hinge body 40.

The retaining body 80 is formed to retain a plurality of bus bars 120 arrayed in the terminal array direction. The retaining body 80 in this example includes housing chambers 81 for each bus bar 120, and is coupled to the housing body 20 (FIGS. 1 and 2). Moreover, in the retaining body 80, a housing chamber 82 for electrical wires (depiction omitted) is also provided. The electrical wires electrically couple the bus bar 120 to the battery monitoring unit 300. Then, in the retaining body 80, a lid 83 that closes up the opening of the housing chamber 82 is also provided.

As in the foregoing, the housing member 10 includes the reference retaining mechanisms (the second and third retaining mechanisms 60 and 70) of the reference opening 20a₁ side on which the hinge body 40 is provided and the offset retaining mechanism (the first retaining mechanism 50) of the offset opening 20a₂ side that is offset with respect to the reference opening 20a₁. Accordingly, assuming that the first retaining mechanism 50 be the same as those conventional ones that exert pressing force on each other as with the second retaining mechanism 60 and the like, in the housing member 10, when making the second and third retaining mechanisms 60 and 70 fully engage, or in the course of the operation of engaging the second and third retaining mechanisms 60 and 70, the first engaging body 51 of the first retaining mechanism 50 and the first engaged body 52 collide, and the turning trace of the hinge body 40 is no longer possible to retain. Thus, in the conventional form, it may be not possible to make the first retaining mechanism 50 be fully engaged, or even when it can be fully engaged, an excessive load may be exerted on mainly the first engaging body 51 and the first engaged body 52. However, because the housing member 10 in the embodiment avoids exerting the pressing force between the first engaging body 51 and the first engaged body 52, the first to the third retaining mechanisms 50, 60, and 70 can be all fully engaged, without defying the turning trace of the hinge body 40. Accordingly, the housing member 10 can retain the closed state of the lid 30 with respect to the housing opening 20a of the housing body 20 and can improve the closure of the housing chamber 20b. Then, because the housing member 10 can, along with the improvement of the closure, suppress the entry of a foreign object into the housing chamber 20b, it is also possible to improve the protection function of the object that is housed in the housing chamber 20b.

Furthermore, because the housing member 10 can, without defying the turning trace of the hinge body 40, make all the first to the third retaining mechanisms 50, 60, and 70 fully engage, it is possible to suppress the occurrence of an excessive load with respect to the first to the third retaining mechanisms 50, 60, and 70 at the time of engaging operation. Thus, the housing member 10 can improve the durability of the first to the third retaining mechanisms 50, 60, and 70, which can further improve the closure of the housing chamber 20b.

In the housing member 10, the movement between the first engaging body 51 and the first engaged body 52 lies along the turning trace of the hinge body 40, and by only performing the turning operation between the housing body 20 and the lid 30 by the hinge body 40, the first engaging body 51 and the first engaged body 52 are ultimately made into a fully engaged state, without exerting the pressing force on each other. Thus, the housing member 10 can, by making the reference retaining mechanism (at least the second retaining mechanism 60) fully engage, make the first retaining mechanism 50 also fully engage, without applying a load needed for full engagement to the first retaining mechanism 50 as the offset retaining mechanism. Meanwhile, in the case of the foregoing hypothetical structure (the first retaining mechanism 50 is the same as those that exert the pressing force on each other as with the second retaining mechanism 60 and the like), assuming that the full engagement of the first retaining mechanism 50 is possible, it needs to apply the load needed for the full engagement thereof to the first retaining mechanism 50 also. However, because the housing member 10 in the embodiment can close the lid 30 in the same working process as that of a conventional housing opening with no step, it is possible to improve the closure of the housing chamber 20b without deteriorating the assembly workability.

In this example, it has been described that the first to the third retaining mechanisms 50, 60, and 70 are all provided. However, depending on the length of the reference opening 20a₁ (the first opening 20a₁) in the terminal array direction, for example, the housing member 10 only needs to include at least one each of the reference retaining mechanism and the offset retaining mechanism as in the foregoing. For example, at least one each of the first retaining mechanism 50 and the second retaining mechanism 60 may be provided, or at least one each of the first retaining mechanism 50 and the third retaining mechanism 70 may be provided. That is, the housing member 10 does not necessarily include, as an object to be installed with respect to the reference opening 20a₁, both the second retaining mechanism 60 and the third retaining mechanism 70. The housing member 10 without the second retaining mechanism 60 or the third retaining mechanism 70 can still provide the same effects as those illustrated in the foregoing.

The housing member according to the present embodiment includes the retaining mechanisms on the reference opening side (at least the second retaining mechanism) on which the hinge body is provided, and the retaining mechanism on the offset opening side (the first retaining mechanism) that is offset with respect to the reference opening. However, because the first retaining mechanism avoids exerting the pressing force between the first engaging body and the first engaged body, the housing member can all make the respective retaining mechanisms fully engage, without defying the turning trace of the hinge body. Thus, the housing member can retain the closed state of the lid with respect to the housing opening of the housing body and can improve the closure of the housing chamber.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A housing member comprising:
a housing body that houses at least a conductive member as an object to be housed via a housing opening including a plurality of openings forming a step;
a lid that closes up the housing opening by closing portions for the respective openings;
a hinge body that couples a reference-opening edge portion forming a reference opening out of the openings, to an end portion of a reference closing portion as the closing portion of the reference opening, and lets the lid turn with respect to the housing body between an opened position with respect to the housing opening and a closed position with respect to the housing opening;
a first retaining mechanism that includes a first engaging body that is arranged between an offset opening in parallel with the reference opening out of the openings, and an offset closing portion as the closing portion closing up the offset opening, and is provided on one of a turning axis side of the hinge body in an offset-opening edge portion forming the offset opening and the turning axis side in an end portion of the offset closing portion, and a first engaged body provided on the other of the turning axis side, and that retains the lid to the housing body at the closed position with a relative turning operation between the housing body and the lid via the hinge body along with full engagement between the first engaging body and the first engaged body; and
a second retaining mechanism that includes a second engaging body and a second engaged body arranged between the reference-opening edge portion and an end portion of the reference closing portion, and that retain the lid to the housing body at the closed position with full engagement between the second engaging body and the second engaged body along with a relative turning operation between the housing body and the lid via the hinge body, wherein
the first engaging body and the first engaged body are formed such that no pressing force is exerted on the other until being fully engaged with each other.

2. The housing member according to claim 1, wherein
the first engaging body and the first engaged body are formed so as to avoid coming in contact with each other until being fully engaged with each other.

3. The housing member according to claim 1, wherein
the first engaging body includes two leg portions that are spaced apart from each other and extend from one of the turning axis side in the offset-opening edge portion and the turning axis side in an end portion of the offset closing portion, and a coupling portion that connects end portions of the two leg portions on an extending direction side, and
the first engaged body is a locking claw projecting from the other of the turning axis side in the offset-opening edge portion and the turning axis side in the end portion of the offset closing portion, and includes a claw portion that is made into a fully engaged state together with the first engaging body by being inserted into a void portion of the first engaging body including the two leg portions and the coupling portion and being locked to the coupling portion.

4. The housing member according to claim 2, wherein
the first engaging body includes two leg portions that are spaced apart from each other and extend from one of the turning axis side in the offset-opening edge portion and the turning axis side in an end portion of the offset closing portion, and a coupling portion that connects end portions of the two leg portions on an extending direction side, and
the first engaged body is a locking claw projecting from the other of the turning axis side in the offset-opening edge portion and the turning axis side in the end portion of the offset closing portion, and includes a claw portion that is made into a fully engaged state together with the first engaging body by being inserted into a void portion of the first engaging body including the two leg portions and the coupling portion and being locked to the coupling portion.

5. The housing member according to claim 1, further comprising:
a third retaining mechanism that retains the lid to the housing body at the closed position with a third engaging body and a third engaged body arranged between the reference-opening edge portion and an end portion of the reference closing portion and the third engaging body and the third engaged body being fully engaged along with a relative turning operation between the housing body and the lid via the hinge body, wherein
the reference-opening edge portion includes an inner-side edge portion on the turning axis side to which the hinge body is coupled, and an outside edge portion that is arranged being spaced apart from the inner-side edge portion,
the end portion of the reference closing portion includes an inner-side end portion on the turning axis side to which the hinge body is coupled, and an outside end portion that is arranged being spaced apart from the inner-side end portion,
the second retaining mechanism is arranged between the inner-side edge portion and the inner-side end portion, and
the third retaining mechanism is arranged between the outside edge portion and the outside end portion.

6. The housing member according to claim 2, further comprising:
a third retaining mechanism that retains the lid to the housing body at the closed position with a third engaging body and a third engaged body arranged between the reference-opening edge portion and an end portion of the reference closing portion and the third engaging body and the third engaged body being fully engaged along with a relative turning operation between the housing body and the lid via the hinge body, wherein
the reference-opening edge portion includes an inner-side edge portion on the turning axis side to which the hinge body is coupled, and an outside edge portion that is arranged being spaced apart from the inner-side edge portion,
the end portion of the reference closing portion includes an inner-side end portion on the turning axis side to which the hinge body is coupled, and an outside end portion that is arranged being spaced apart from the inner-side end portion,
the second retaining mechanism is arranged between the inner-side edge portion and the inner-side end portion, and
the third retaining mechanism is arranged between the outside edge portion and the outside end portion.

7. The housing member according to claim 3, further comprising:
a third retaining mechanism that retains the lid to the housing body at the closed position with a third engaging body and a third engaged body arranged between the reference-opening edge portion and an end portion of the reference closing portion and the third engaging body and the third engaged body being fully engaged along with a relative turning operation between the housing body and the lid via the hinge body, wherein
the reference-opening edge portion includes an inner-side edge portion on the turning axis side to which the hinge body is coupled, and an outside edge portion that is arranged being spaced apart from the inner-side edge portion,
the end portion of the reference closing portion includes an inner-side end portion on the turning axis side to which the hinge body is coupled, and an outside end portion that is arranged being spaced apart from the inner-side end portion,
the second retaining mechanism is arranged between the inner-side edge portion and the inner-side end portion, and
the third retaining mechanism is arranged between the outside edge portion and the outside end portion.

8. The housing member according to claim 1, wherein
the opening arranged at an innermost location, out of the openings, is set to as the reference opening.

9. The housing member according to claim 2, wherein
the opening arranged at an innermost location, out of the openings, is set to as the reference opening.

10. The housing member according to claim 3, wherein
the opening arranged at an innermost location, out of the openings, is set to as the reference opening.

11. The housing member according to claim 5, wherein
the opening arranged at an innermost location, out of the openings, is set to as the reference opening.

12. The housing member according to claim 1, wherein
the conductive member is an electrical wire electrically coupled to one of two electrode terminals that a plurality of arrayed battery cells include and to a battery monitoring unit that monitors a battery status of the battery cells, and/or an electrical wire that electrically couples a temperature detecting device configured to detect temperature of the battery cells to the battery monitoring unit.

13. The housing member according to claim 2, wherein
the conductive member is an electrical wire electrically coupled to one of two electrode terminals that a plurality of arrayed battery cells include and to a battery monitoring unit that monitors a battery status of the battery cells, and/or an electrical wire that electrically couples a temperature detecting device configured to detect temperature of the battery cells to the battery monitoring unit.

14. The housing member according to claim 3, wherein
the conductive member is an electrical wire electrically coupled to one of two electrode terminals that a plurality of arrayed battery cells include and to a battery monitoring unit that monitors a battery status of the battery cells, and/or an electrical wire that electrically couples a temperature detecting device configured to detect temperature of the battery cells to the battery monitoring unit.

15. The housing member according to claim 5, wherein
the conductive member is an electrical wire electrically coupled to one of two electrode terminals that a plurality of arrayed battery cells include and to a battery monitoring unit that monitors a battery status of the battery cells, and/or an electrical wire that electrically couples a temperature detecting device configured to detect temperature of the battery cells to the battery monitoring unit.

16. The housing member according to claim 8, wherein
the conductive member is an electrical wire electrically coupled to one of two electrode terminals that a plurality of arrayed battery cells include and to a battery monitoring unit that monitors a battery status of the battery cells, and/or an electrical wire that electrically couples a temperature detecting device configured to detect temperature of the battery cells to the battery monitoring unit.
